(19) United States
(12) Patent Application Publication
(10) Pub. No.: US 2026/0353322 A1
(43) Pub. Date: Nov. 5, 2026

(54) DEVICES, METHODS, AND SYSTEMS THAT COMBINE DOWNLINK AND UPLINK TIME DIFFERENCE OF ARRIVAL TECHNIQUES

(71) Applicant: Qorvo US, Inc., Greensboro, NC (US)

(72) Inventors: Alexander Ivanov, Dublin (IE); Shadi Hawawini, Mountain View, CA (US)

(21) Appl. No.: 19/485,770

(22) PCT Filed: May 13, 2024
(86) PCT No.: PCT/US2024/029151

§ 371 Date: Nov. 19, 2025

Related U.S. Application Data
(60) Provisional application No. 63/512,431, filed on Jul. 7, 2023.
(60) Provisional application No. 63/603,836, filed on Nov. 29, 2023.

(51) Int. Cl. H04W 56/00; H04B 1/7163; H04W 64/00

(52) U.S. Cl. CPC H04W 56/0015; H04B 1/7163; H04W 64/00

(57) ABSTRACT

A method of operating an anchor in a communication system is presented herein. In some aspects, the method includes receiving an uplink message having a preamble from a mobile device, and receiving a synchronization message having a second preamble from a second anchor, wherein synchronization of the anchor is based on the synchronization message, and wherein the second preamble is different than the preamble. The anchor may be an anchor in an ultra-wideband (UWB) network, and the mobile device may include a UWB tag. Moreover, embodiments of the present disclosure include systems, devices, and methods that combine downlink and uplink time difference of arrival techniques.

### CROSS-REFERENCE TO RELATED APPLICATIONS

The present application claims the benefit of U.S. Provisional Application No. 63/512,431, filed Jul. 7, 2023, and U.S. Provisional Application No. 63/603,836, filed, Nov. 29, 2023, both of which are incorporated herein by reference in their entirety.

### TECHNICAL FIELD

The present disclosure relates generally to ultra-wideband-enabled devices, methods, and systems for facilitating the determination and/or tracking of location of physical objects and, more particularly, to mitigating the effects of collisions of blinks transmitted from objects and synchronization messages from anchors.

### BACKGROUND

Ultra-wideband (UWB) refers to a wireless technology developed to transmit data at a high data rate over short distances in a power efficient manner. In some cases, UWB is a general term that a general term for radio communication that uses a bandwidth close to or greater than 500 MHz. UWB radio technology enables the location of objects to be determined and tracked with high accuracy. UWB may use a time difference of arrival (TDoA) techniques to facilitate location accuracy.

TDoA-based localization schemes in UWB may be divided into an uplink TDoA scheme using a signal transmitted by objects (e.g., electronic devices) sometimes referred to in the UWB context as tags, and a downlink TDoA scheme using signals transmitted by devices referred to in the UWB context as anchor nodes. Anchor nodes may also be referred to as network devices or access points.

In uplink (UL) TDoA schemes, when anchor nodes receive an uplink signal from a tag, sometimes referred to as a UT-Tag, the uplink signal arrives at the anchor nodes at different times according to the locations of the anchor nodes. The anchor nodes in UL TDoA are sometimes referred to as UT-Anchors in the FiRa context. A central station may estimate the location of the tag using arrival time differences (i.e., TDoAs) of the uplink signal. UL TDoA may be used for tracking assets via the use of tags, for example.

In downlink (DL) TDoA schemes, the location of a tag may be calculated using TDoAs related to times at which the tag receives downlink signals transmitted by different anchor nodes. The anchor nodes may transmit their downlink signals in given time slots (also referred to as slots) or time periods. DL TDoA may be used by tags for navigation, for example.

The FiRa Consortium (“FiRa” stands for “fine ranging”) is a group of member companies developing UWB technical specifications to ensure interoperability among chipsets and devices and promote the adoption of UWB technologies for location-based services. In some contexts, FiRa standards describes separately Downlink(DL) and Uplink(UL) TDoA techniques. Both techniques are infrastructure based (e.g., have anchors set on the ceiling/walls in a specific order, such as in a shopping center). FiRa represents widely supported and popular standards on top of 802.15.4 a/z, which can be understood as clarifying certain aspects and data structures of 802.15.4 a/z.

In an ideal UL-TDoA scenario, anchors would never transmit and listen for blinks all of the time. In practice, this ideal is not possible, as the anchors in the system may need to have some synchronization scheme to have a common clock domain. Thus, there is a need to wirelessly synchronize the clock of anchors in UL-TDoA systems while providing efficient and reliable location tracking to receive blinks from tags.

### SUMMARY

Embodiments of the present disclosure include systems, devices, and methods that combine downlink and uplink TDoA techniques.

In an exemplary aspect, a method of operating an anchor in a communication system is presented herein. In some aspects, the method includes receiving an uplink message having a preamble from a mobile device, and receiving a synchronization message having a second preamble from a second anchor, wherein synchronization of the anchor is based on the synchronization message, and wherein the second preamble is different than the preamble. The anchor may be an anchor in an UWB network, and the mobile device may include a UWB tag.

In other exemplary aspects, an anchor is described. The anchor may include a transceiver. In further aspects, the transceiver is configured to receive an uplink message having a preamble from a mobile device, and receive a synchronization message having a second preamble from a second anchor. In further aspects, synchronization of the anchor is based on the synchronization message, and the second preamble is different than the preamble. In further aspects, the uplink message may be a blink, and the mobile device may be a UT-Tag, and the anchor may be configured to be part of an ultrawideband network.

In other exemplary aspects, an UWB device is described. The UWB may include a transceiver, a processor, and a non-transitory memory. In further aspects, the non-transitory memory includes a set of instructions stored therein and executable by the processor to cause the transceiver to perform various functions, including receive an uplink message having a preamble from a mobile device, and receive a synchronization message having a second preamble from an anchor. In further aspects, synchronization of the UWB device is based on the synchronization message, and the second preamble is different than the preamble. In further aspects, the uplink message may be a blink, and the mobile device may be a UT-Tag, and the anchor may be configured to be part of an ultrawideband network.

Additional aspects, features, and advantages of the present disclosure will become apparent from the following detailed description.

### BRIEF DESCRIPTION OF THE DRAWINGS

The accompanying drawing figures incorporated in and forming a part of this specification illustrate several aspects of the disclosure, and together with the description, serve to explain the principles of the disclosure.

FIG. 1 is a diagram illustrating a time difference of arrival (TDoA)-based localization system, according to some aspects of the present disclosure.

FIG. 2 illustrates an example of mobile device, according to some aspects of the present disclosure.

FIG. 3 illustrates an example of an anchor, according to some aspects of the present disclosure.

FIG. 4 illustrates an example system, according to some aspects of the present disclosure.

FIG. 5 illustrates an example system, according to some aspects of the present disclosure.

FIG. 6 illustrates downlink and uplink transmissions in a UWB system that include multiple anchors and one or more tags, according to some aspects of the present disclosure.

FIGS. 7A and 7B illustrate a system along with a number of timing diagrams for messages transmitted in the system, according to some aspects of the present disclosure.

FIG. 8 illustrates a method of synchronizing anchors and receiving blinks in a wireless network, according to some aspects of the disclosure.

### DETAILED DESCRIPTION

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

In some scenarios, for the purpose of synchronization, synchronization (SYNC) messages are transmitted wirelessly by at least one anchor periodically, particularly in DL-TDoA systems. Using known techniques, it is possible to include in anchors or in the location engine algorithms that can compensate for anchor clock drifts and effectively report all the received UL-blinks from the UT-Tags in a common time domain. However, because UL-Tags (or simply tags) typically transmit blinks at random and unpredictable times using ALOHA protocols, blinks may collide with synchronization messages transmitted by anchors. Collisions of blinks with inband synchronization messages can negatively impact the quality of the synchronization in the UL-TDoA anchors and lead to larger errors in tag location estimation and tracking. Thus, there is a need to mitigate the effects of collisions between synchronization messages transmitted by anchors and blinks transmitted by tags.

Exemplary embodiments of messaging and protocols are presented herein that permit anchors to communicate synchronization messages among each other to synchronize clocks while also providing for reliable and efficient reception of blink messages by the anchors to track the location of tags in the system. In some embodiments, the techniques combine aspects of FiRa DL-TDoA and UL-TDoA schemes. For example, a portion of time is set aside in a cluster of anchors for the anchors to communicate synchronization messages among each other in the form of polling messages, such as DT-Poll messages for the purpose of UT-SYNC messages, akin to DL-TDoA using FiRa nomenclature. Remaining time periods for the cluster are used for anchors to receive blink messages from tags in range of the cluster, allowing for location tracking of tags using UL-TDoA. To mitigate the effects of interference between blinks and synchronization messages, different preambles are used, resulting in low or zero cross-correlation among blink messages and synchronization messages and allowing anchors to distinguish the two types of messages.

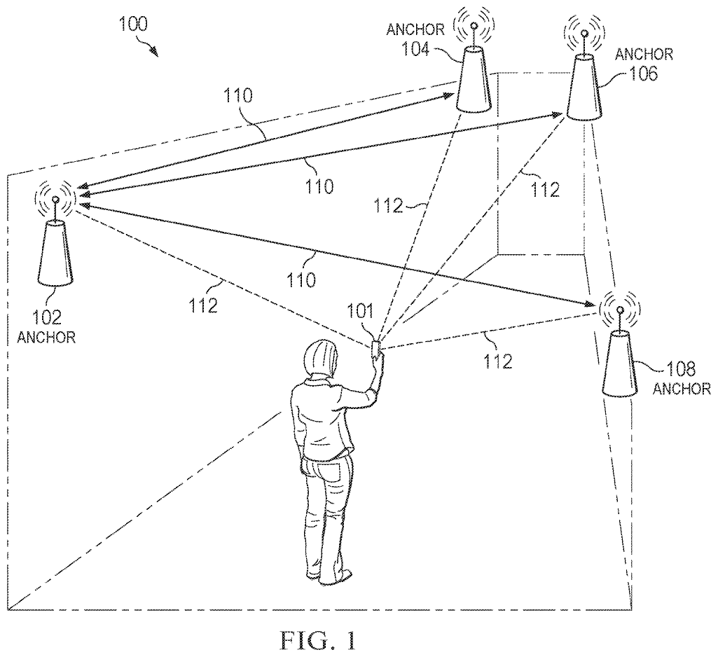

FIG. 1 is a diagram illustrating a time difference of arrival (TDoA)-based localization system 100, according to aspects of the present disclosure. The system includes an electronic device 101 equipped with downlink and uplink UWB capability, although the device 101 may be equipped with only downlink UWB capability (for DL-TDoA) or only uplink UWB capability (for UL-TDoA). The electronic device 101 is illustrated as a handheld or smartphone-type device, but the device 101 may be any sort of physical object equipped with UWB capability and is generally an example of a tag in UWB art. For example, objects moving around a manufacturing environment may be tracked using UWB technology, so another example device 101 may be an object moving around a manufacturing facility. In other use cases, an example device 101 may be affixed to any object whose location is desirable to be estimated or tracked.

The system 100 also includes multiple of anchor nodes. In this example, there are four anchor nodes in this system 100, labeled as 102, 104, 106, and 108. The anchor nodes 102, 104, 106, and 108 may be pre-installed, and information about the locations of the anchor nodes 102, 104, 106, and 108 may be stored in the electronic device 101 which is movable. According to an embodiment of the disclosure, the information about the locations may be transmitted wirelessly to the electronic device 101 or pre-stored in the electronic device 101. According to another embodiment, the information about the locations may be stored in a server (not shown) , and the electronic device 101 may download the information about the locations from the server.

The anchor nodes 102, 104, 106, and 108 may be located on a line of sight (LOS) of the electronic device 101. The transmission timings and roles (e.g., initiator or responder) of the anchor nodes 102-108 in a given slot may be pre-configured prior to a TDoA operation for localization of the electronic device 101. For example, a master anchor (e.g., the anchor node 102), which is one of the plurality of anchor nodes, may manage the transmission timings of the anchor nodes 102, 104, 106, and 108. In some embodiments, the location of an anchor node is generally fixed in the network.

In a DL TDoA scheme, the electronic device 101 may overhear, through radio channels 110, DL TDoA frames are exchanged on communication channels 110 among the anchor nodes 102, 104, 106, and 108, and measure the reception times of the DL TDoA frames. For example, the electronic device 101 may measure TDoAs for at least three anchor nodes, for localization of the electronic device 101 in a two-dimensional space, and may use TDoAs for at least four anchor nodes for localization of the electronic device 101 in a three-dimensional space. The electronic device 101 may calculate its location based on the TDoAs and the given locations of the anchor nodes 102, 104, 106 and 108.

In a UL TDoA scheme, the electronic device 101 may transmit, on the radio channels 112, a UL TDoA frame including identification information (e.g., a medium access control (MAC) address) about the electronic device 101, which is receivable at neighboring anchor nodes (e.g., the anchor nodes 102, 104, 106, and 108). For example, the anchor nodes 102, 104, and 106 may receive an UL TDoA frame and share measured TDoA values for the UL TDoA frame or report the measured TDoA values to the electronic device 101 or a server having a location engine (not shown), and the location of the electronic device 101 may be calculated based on the TDoA values and the locations of the anchor nodes 102, 104, and 106.

Mobile device 101 may include a cellular telephone, a smartphone, a laptop computer, a tablet, a personal digital assistant (PDA), a computing device, wearable devices (e.g., a smart watch, or the like), or any other mobile device having wireless connection capability. Although only a single mobile device 101 is shown in FIG. 1, one of ordinary skill in the art will appreciate that multiple mobile devices may connect with the anchor nodes 102, 104, 106, 108. The number of mobile devices (tags) in a system, such as system 100

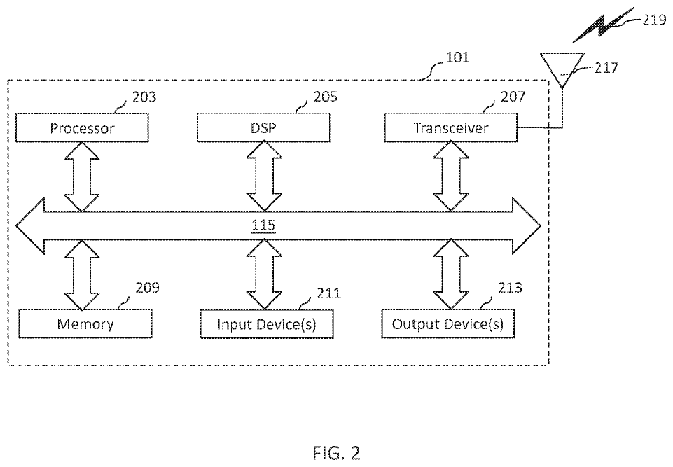

FIG. 2 illustrates an example of mobile device 101, according to some aspects of the present disclosure. Mobile device 101 may be a cellular telephone, a smartphone, a laptop computer, a tablet, a personal digital assistant (PDA), a computing device, or any other mobile device having wireless connection capability. In some embodiments, mobile device 101 includes a processor 203, a digital signal processor (DSP) 205, a transceiver 207, an antenna 217, a memory 209, an input device 211, an output device 213, and a bus 215. The hardware components of mobile device 101 may be communicatively coupled to bus 215. In some embodiments, bus 215 can be used for processor 203 to communicate between cores and/or with memory 209. Processor 203 may include one or more general-purpose processors and/or one or more special-purpose processors (such as digital signal processing chips, graphics acceleration processors, and/or the like). Processor 203 may process wireless signals 219 received by transceiver 207, such as ranging signal/data from UWB communication. Input device 211 may include a camera, a mouse, a keyboard, a touch sensitive screen/display, a touch pad, a keypad, and/or the like. An output device 213 may include a display, a printer, and/or the like. In some embodiments, a user may load a pairing and configuring application, which automatically turns on the camera, which has a field of view (FOV).

Mobile device 101 may include a transceiver 207 communicatively coupled to bus 215. Transceiver 207 may be configured to transmit and/or receive wireless signals 219 via antenna 217. The transceiver 207 may be implemented as separate transmitter and receiver components, or some combination of separate and shared transmitter and receiver components, such as radio frequency circuitry. Wireless signals 219 may be transmitted/received via a wireless network. In some embodiments, the wireless network may be any wireless network such as a local wireless network (e.g., local wireless network 102), such as WiFi, a Personal Access Network (PAN), such as Matter, Bluetooth® or Zigbee®, or a cellular network (e.g., 4G, 5G). Transceiver 207 may be configured to receive signals 219 via antenna 217 from anchors (network devices) (e.g., 102, 104, 106, 108, or the like). Mobile device 101 may also be configured to decode and/or decrypt, via the DSP 205 and/or processor 203, various signals received from anchors, such as anchors 102, 104, 106, 108. Although illustrated as a single antenna 217, antenna 217 may represent multiple antennas, with one or more antennas used for UWB communication, and one or more antennas used for other types of communication, such as cellular or WiFi communication.

The mobile device 101 may include fewer than all the components illustrated in FIG. 2. For example, if the mobile device 101 is configured to include tag functionality as an Internet of Things (IOT) device, the mobile device 101 may not include input device(s) 211 or output device(s) 213. The processor 203 and/or DSP 205 may be implemented as a UWB chip to process UWB signals transmitted or received by transceiver 207.

The mobile device 101 may be configured to operate only as an UL tag (a UT-Tag in FiRa nomenclature), in which case the mobile device 101 may be equipped with only an UWB transmitter, e.g., implemented as transceiver 207. Or the mobile device 101 may be configured to operate as both an UL tag and a DL tag, in which case the mobile device may be equipped with both a UWB transmitter and a UWB receiver, e.g., implemented as transceiver 207.

Memory 209 may include one or more non-transitory storage devices that can include local and/or network accessible storage, a disk drive, a drive array, an optical storage device, a solid-state storage device such as a random access memory (“RAM”) and/or a read-only memory (“ROM”), a programmable ROM, a flash-updateable ROM, and/or the like. Such storage devices may be configured to implement any appropriate data storage, including without limitation, various file systems, database structures, and/or the like. In some embodiments, a device database, including device information (e.g., device identification (ID), device keys, vendor information, device type, etc.) of one or more of anchors, such as anchors 102, 104, 106, 108.

In various embodiments, functions/operations may be stored as one or more instructions or code in memory 209, such as on a computer-readable storage medium, such as RAM, ROM, FLASH, or disc drive, and executed by processor 203 or DSP 205. Mobile device 101 may also include software components (e.g., located within memory 209), including, for example, an operating system, device drivers, executable libraries, and/or other executable code, such as one or more application programs. The application programs may include computer programs, stored in memory 209, executed by processor 203 and/or DSP 205 to implement various functions under the control of the operating system. The computer programs may have been pre-packaged with mobile device 101 or may have been downloaded by a user into memory 209 of the mobile device 101.

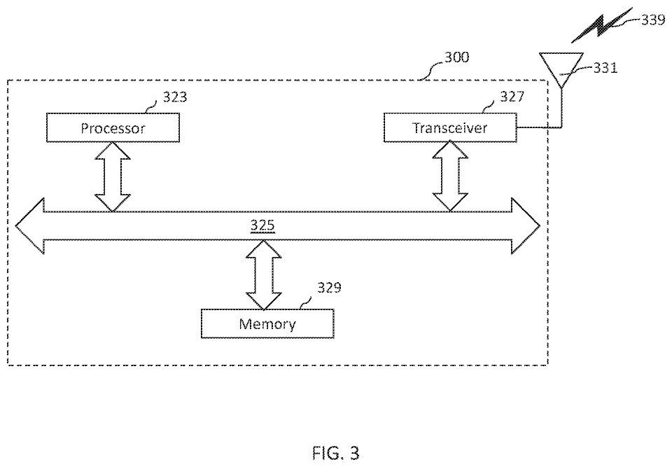

FIG. 3 illustrates an example of an anchor 300, such as any of anchors 102, 104, 106, 108 or anchors in the other figures, according to some aspects of the disclosure. Anchor 300 may include a transceiver 327 and an antenna 331 (communicatively coupled to transceiver 327) for wireless communication with mobile devices, such as mobile device 101. Depending on the type, anchor 300 may optionally include a processor 323, a memory 329, and a bus 325.

Transceiver 327 may be operable to transmit and receive wireless signals 339 via antenna 331. Wireless signals 339 may be transmitted/received via a wireless network. In some embodiments, the wireless network may be any wireless network such as a local wireless network, such as WiFi, a Personal Access Network (PAN), such as Matter, Bluetooth® or Zigbee®, or a cellular network (e.g., 4G, 5G). Transceiver 327 may be configured to receive wireless signals 339 via antenna 327 from a network control device (not show), a mobile device (e.g., 101), and/or the like. Optionally, anchor 300 may include a DSP (not show) for decoding and/or decrypting, various received signals 339.

Optionally, anchor 300 may include a processor 323 and a memory 329. Processor 323 may include one or more general-purpose processors and/or one or more special-purpose processors, similar to processor 203. Memory 329 may include one or more non-transitory storage devices, similar to memory 209. Optionally, anchor 300 may include a bus 325 that communicatively couples processor 323, transceiver 327, and memory 329 such that processor 323 may execute instructions stored in memory 329 and may process signals 339 received by transceiver 327, such as ranging signal/data from UWB communication. In some embodiments, memory 329 may be stored with position information of one or more network devices. For example, memory 329 may be stored with relative position information of one or more other network devices, absolute position information for one or more network devices, etc.

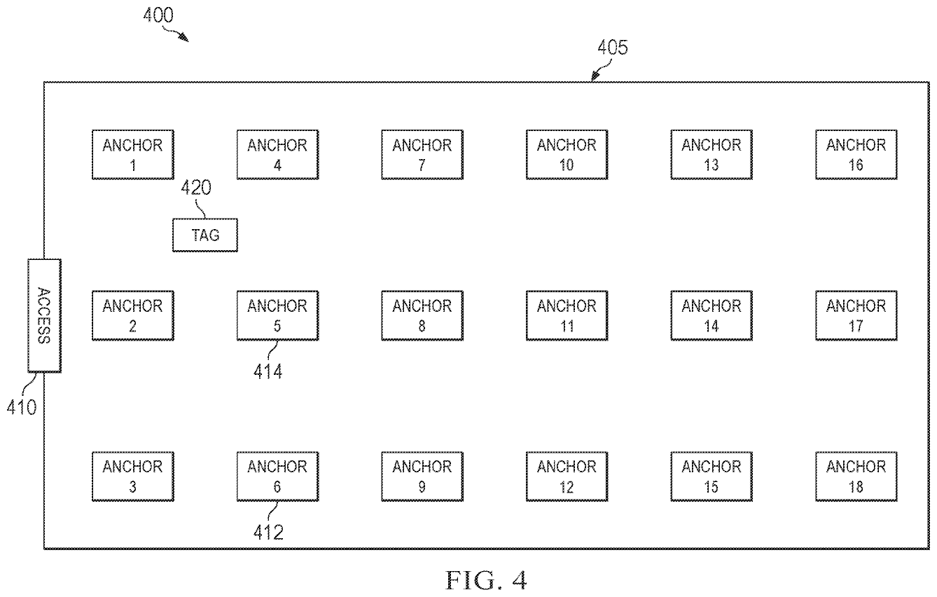

FIG. 4 illustrates an example system 400, according to some aspects of the present disclosure. The system 400 exists in an example physical space 405. In this example embodiment, the system 400 includes 18 anchors, an exemplary two of which are designated as 412, 414, although other layouts may include any number of anchors, and the anchors are positioned in the physical space 405. The system 400 also includes a number of tags, one of which is indicated as tag 420. A typical system, such as system 400, may accommodate dozens or hundreds of tags. In this exemplary space 405, there is an access 410 to enter and/or exit the space. In this space, tags, such as tag 420, may enter or exit the space 405 via access 410. The anchors may be configured to provide DL TDoA UWB communication so that the tag 420 (sometimes referred to as a DL-Tag in this context) can receive DL transmissions from one or more anchors (e.g., three or more anchors) and, based on the receiving, estimate its location with a high degree of accuracy. The anchors may be configured to provide UL TDoA UWB communication, via transmissions sometimes referred to as blinks, so that one or more anchors (e.g., three or more anchors) can receive the UL communication, and based on the communication, estimate the location of the tag 420 (sometimes referred to as an UL-Tag in this context) with a high degree of accuracy.

The system 400 may represent an installation in a physical space 405 of various dimensions, such as 40 meters (m)×100 m, for example. In a typical installation the anchors may be installed on the perimeter, either walls or ceiling, with intermediate infrastructure elements to cover the desired distances.

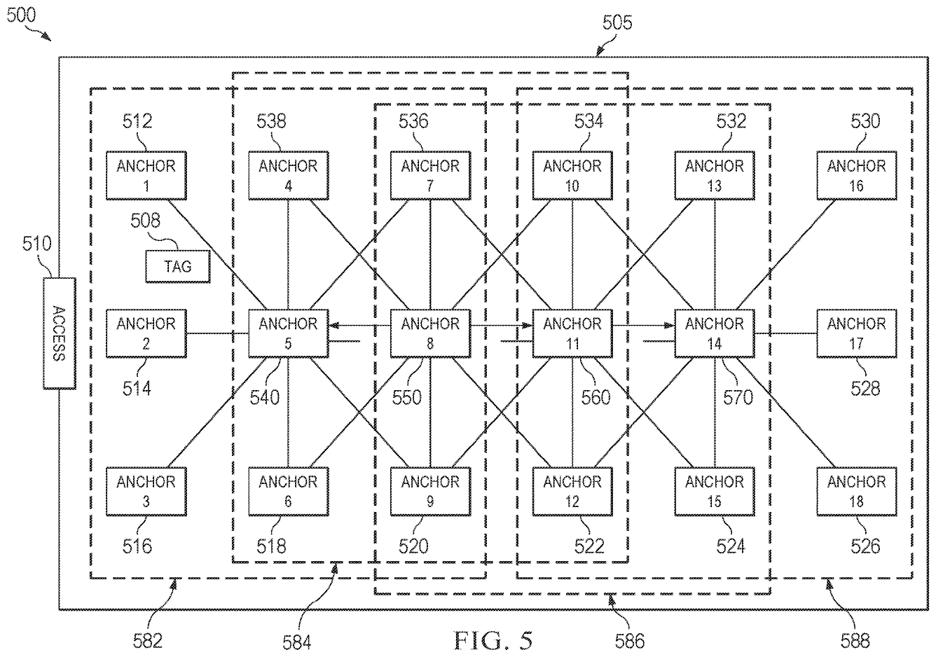

FIG. 5 illustrates an example system 500, according to some aspects of the present disclosure. The system 500 exists in an example physical space 505. The system 500 includes a number of anchors, and clusters of anchors, positioned in a physical space 505, as shown. This example layout includes 18 anchors, designated as shown, although other layouts may include any number of anchors. In this exemplary space 505, there is an access 510 to enter and/or exit the space. In this space, tags, such as tag 508, may enter or exit the space 505 via access 510.

Anchors may be organized into clusters. For example, there are four clusters shown in FIG. 5, labeled as a first cluster 582, a second cluster 584, a third cluster 586, and a fourth cluster 588. In some embodiments, a cluster is a set of anchors that exchange messages to provide a positioning service to tags in an area or region served by a cluster. Clusters may exchange synchronization messages, sometimes referred to as synchronization uplink TDoA messages (UTM), to synchronize clocks among anchors. At least some of the anchors, such as anchors 540, 550, 560, and 570, may be designated and serve as UL synchronization anchors, serving their respective clusters. Some of the anchors, such as anchors 540, 550, 560, and 570, are parts of more than one cluster, as shown in FIG. 5. For example, anchor 550 is part of clusters 582, 584, and 586 as shown.

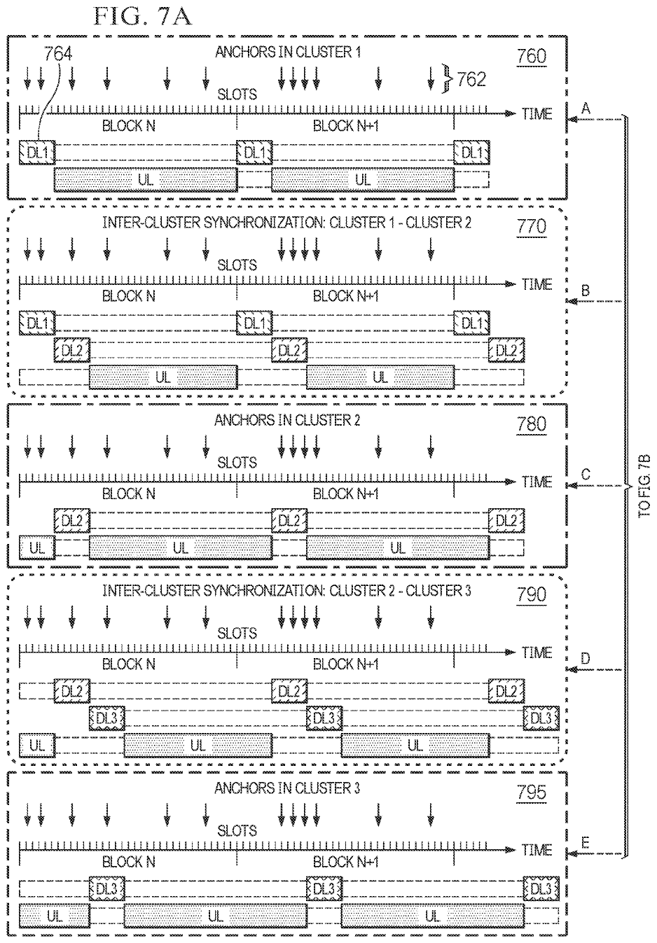

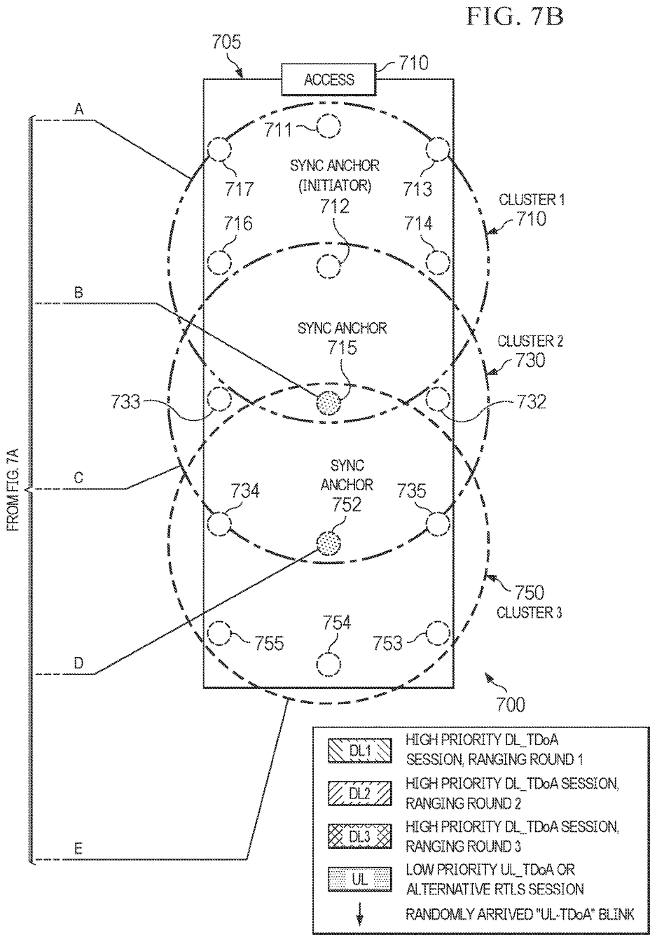

The anchors may be configured in a master-slave relationship with respect to synchronization functions, with synchronization anchors serving as masters in their respective clusters and the other anchors in the cluster serving as slaves. Furthermore, the synchronization anchors may be configured in a hierarchical manner. For example, synchronization anchor 550 may be designated as a primary master, which may also be referred to as an initiator synchronization anchor. In some embodiments, the role of an initiator synchronization anchor is to maintain the master clock for the system/network. The role of an initiator anchor is discussed more in reference to FIGS. 7A and 7B. Continuing the example, the synchronization anchors 540, 560, and 570 receive synchronization messages and establish clock references among anchors in their clusters 582, 586, and 588, respectively.

In the common space 505, tags, such as tag 508, may enter or exit the space 505 via an access, such as access 510. The anchors may be configured to provide UL TDoA UWB communication, via transmissions sometimes referred to as blinks, so that one or more anchors (e.g., three or more anchors) can receive the UL communication, and based on the communication, estimate the location of the tag 520 (sometimes referred to as an UL-Tag in this context) with a high degree of accuracy.

UL synchronization anchors may periodically send synchronization UTMs to enable in-band wireless clock synchronization. In addition, UT-Synchronization Anchors listen for blink UTMs from tags (sometimes referred to as UT-Tags), such as tags and synchronization UTMs from other UL synchronization anchors, reporting via an UL command interface (UCI) notifications the RX timestamps of the messages received. In an embodiment, each UT-Tag is an FiRa Device that transmits blink UTMs in order to be located by the anchor infrastructure. In some embodiments, DT-Poll message formats used in DL-TDoA systems can be used as synchronization UTM formats for UL TDoA, with the preamble of the DT-Poll messages set to be different than the preamble used for blink UTMs.

The presently disclosed techniques apply to UL TDoA. Within UL TDoA, in some embodiments, a portion of each time interval, such as a block or frame, is designated for UL synchronization anchors to transmit synchronization messages and for other anchors to listen for synchronization messages. During these portions of time, features of DL TDoA are used for synchronization among the anchors. Meanwhile, blinks continue to be transmitted in an uncontrolled manner from tags. Therefore, there is a possibility that blinks will collide with synchronization messages. This disclosure presents techniques for mitigating these collisions.

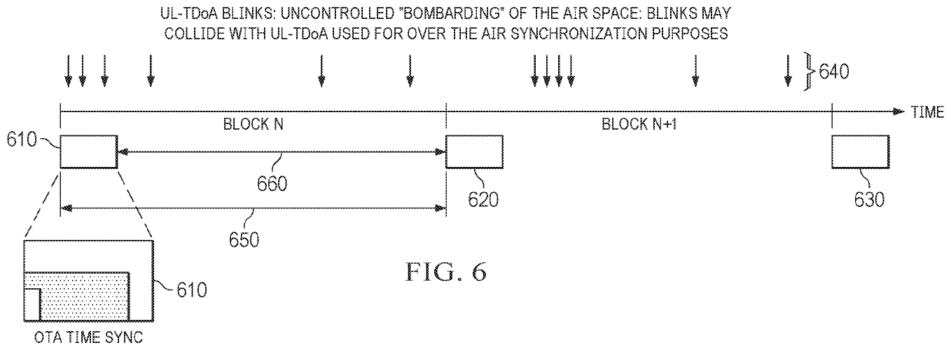

FIG. 6 illustrates downlink and uplink transmissions in a UWB system, such as the systems 400 and 500, that include multiple anchors and one or more tags, according to some aspects of the present disclosure. The system is configured to operate mainly in an UL TDoA mode. However, a certain portion of each block is designated for over-the-air (OTA) synchronization message transmissions from one or more synchronization anchors, akin to a DL TDoA mode. These portions are represented as 610, 620, and 630 in consecutive blocks of time, and these portions (which may be thought of as DL TDoA portions) are used to organize the UWB airspace. The time period 650 represents a fixed, periodic time unit, which may be referred to as a block. Blocks may, for example, be 100 milliseconds (ms), 200 ms, 300 ms, etc. Blocks may in turn consist of a fixed number of slots.

The arrows 640 represent the arrival of blink messages transmitted by tags in the system. The blink messages may be transmitted in an uncontrolled manner, such as in an ALOHA protocol, where there is no coordination among different tags regarding when they may transmit blink messages. As shown, it is possible that blink messages collide with synchronization messages.

There are time periods when synchronization messages are not being transmitted by synchronization anchors, such as the time period indicated as 660. In these time periods, all anchors in a cluster of anchors are in listening mode, listening for blinks from tags. In some embodiments, a FiRa DL-TDoA initiation message is used for the purpose of the UL TDoA synchronization message. Beneficially, the synchronization messages transmitted from synchronization anchors use different preambles than the blink messages. It is well known in the FiRa art that a preamble code index can be used to specify the preamble used in a message, such as blink and synchronization messages. For example, synchronization messages may use a preamble designed by one of preamble code indexes 9, 10, 11, or 12, and blinks may use a different one of preamble code indexes 9, 10, 11, or 12. For example, synchronization messages may be configured to use the preamble code indicated by index 9, and blinks may be configured to use the preamble code indicated by index 10, 11, or 12.

Different preamble codes have low cross-correlation, so that if an anchor is expecting a certain preamble code, it will reject a different preamble code with high probability. When receiving a message, an anchor performs a correlation of a preamble field against the preamble code that the anchor is expecting. For example, different preamble codes may be orthogonal or the cross-correlation may be less than 10% of the value of the maximum autocorrelation. In some embodiments, a preamble code (PCode) is used to generate the “Ipatov” or “SYNC” pattern of a frame, using FiRa nomenclature. In some embodiments, the preamble code is set to be the same on both transmitter and receiver sides, and such frames would correlate, providing synchronization for the future determination of the (R-Marker) based on start of frame delimiter (SFD), and reception of scrambled timestamp sequence (STS), and physical header (PHR) and Payload when present.

In some embodiments, in addition to using the preamble code scheme described above, the synchronization messages use different medium access control (MAC) settings than synchronization messages used in FiRa. The settings may be different STS and encryption settings. The STS may be set to zero, for example, for every synchronization message. In some embodiments, in a system complaint with FiRa and using nomenclature of FiRa, a DL-TDoA RI-UTM is used for anchor synchronization messages instead of SYNC-UTM in UL-TDoA.

FIGS. 7A and 7B illustrate a system 700 along with timing diagrams 760, 770, 780, 790, and 795 for messages transmitted in the system, according to some aspects of the disclosure. The system 700 includes 15 anchors as shown, positioned within a physical space 705, such as a shopping center or manufacturing facility. The anchors form a network in which the anchors are wirelessly interconnected. The anchors are organized into clusters 710, 730, 750 for synchronization purposes. The anchors may self-organize into clusters or be manually configured. For example, cluster 1 (710) includes anchors 711, 712, 713, 714, 715, 716, and 717. At least one anchor in each cluster is designated as a synchronization anchor, which transmits synchronization messages in designated time periods. For example, anchor 712 in cluster 1 (710) is a synchronization anchor; anchor 715 in cluster 2 (730) is a synchronization anchor; and anchor 752 in cluster 3 (750) is a synchronization anchor.

The synchronization anchors transmit synchronization messages in a defined order, starting with a synchronization anchor designated as an initiator synchronization anchor. In the system 700, synchronization anchor 712 is an initiator synchronization anchor. An initiator anchor is understood to act as a time reference in the system 700, e.g., maintaining a common clock for the anchors in the system 700. In the timing diagrams, a certain fixed portion of each block is designated for synchronization communication among anchors, and these portions are labeled as “DL” in the timing diagrams. Timing diagram 760 illustrates transmissions that occur in cluster 1. In the time slots DL1, the initiator synchronization anchor transmits synchronization messages, and the remaining anchors in the cluster listen for the synchronization messages. For example, the anchors 711, 713, 714, 715, 716, and 717 listen for the synchronization messages from synchronization anchor 712 during time slots DL1. Also, during DL1, after the remaining anchors receive a synchronization message, the remaining anchors in cluster 1 may send a response message to synchronization anchor 712. In some embodiments, the synchronization messages may take the form of DL UWB poll message formats according to the FiRa specifications.

The arrows in each timing diagram represent blinks transmitted in an uncoordinated manner, such that the blinks may collide with synchronization messages. (For example, the arrows are labeled as 762 in the timing diagram 760.) However, the synchronization messages use a different preamble than the blinks, so that anchors are able to differentiate synchronization messages from blinks, thereby mitigating or negating the effects of any collisions. For example, anchor 716 can distinguish synchronization messages from synchronization anchor 712 from blinks, via the use of the preamble in the synchronization messages.

As shown, the synchronization anchors are scheduled to take turns transmitting synchronization messages, to reduce the probability that synchronization messages collide. For example, in timing diagram 770, inter-cluster synchronization is illustrated. During DL1 (764), the synchronization anchor 715 is in receive mode and able to receive synchronization messages from synchronization anchor 712. In some embodiments, the physical layer configuration of synchronization anchor 715 is switched or configured to receive synchronization messages during time periods DL1, using the preamble designated for synchronization message to recognize a message as a synchronization message. Synchronization anchor 712 may act as an initiator anchor that provides a time reference in the system/network. During DL2, the synchronization anchor 715 switches to transmission mode and transmits its synchronization message. All of the anchors in cluster 2 (730) listen for the synchronization message from the synchronization anchor 715 for that cluster during DL2. Also, during DL2, after the remaining anchors in cluster 2 (i.e., other than sync anchor 715) receive a synchronization message, the remaining anchors in cluster 2 may send a response message.

From the standpoint of the anchors in cluster 2 (730), during the time period labeled as DL1 in timing diagram 770, the anchors in cluster 2 are listening for blinks, as reflected in timing diagram 780. The timing diagram 780 illustrates the timing from the perspective of all anchors in cluster 2, other than synchronization anchor 715. During the time period shown as “UL” in timing diagram 770, the synchronization anchor 715 switches its physical layer configuration to use a different preamble for reception to receive blink messages from tags within range of cluster 2.

During the time synchronization anchor 715 transmits synchronization messages in time period labeled as DL2 in each block, the next synchronization anchor 752 also listens for these synchronization messages. After synchronization anchor 715 transmits synchronization messages in DL2 of each block, it is time for the next synchronization anchor 752 to transmit its synchronization messages. For example, in timing diagram 790, inter-cluster synchronization between cluster 2 (730) and cluster 3 (750) is illustrated. The timing diagram 790 represents activity in the system 700 from the perspective of synchronization anchor 752, which acts as the synchronization anchor for cluster 3 (750).

From the standpoint of the anchors in cluster 3 (750) other than the synchronization anchor 752, during the time period labeled as DL2 in timing diagram 790, the anchors in cluster 3 are listening for blinks, as reflected in timing diagram 795. The timing diagram 795 illustrates the timing from the perspective of all anchors in cluster 3, other than synchronization anchor 752. All time periods marked “UL” represent time periods when anchors associated with a given timing diagram are in listening mode, listening for blinks from tags in the system (not shown). All of the other anchors in cluster 3 (750) listen for the synchronization message from the synchronization anchor 752 for that cluster during DL3. The other anchors in cluster 3 may send a response in response to a synchronization message.

In an embodiment, the preambles used for the synchronization messages are different than the preambles used in synchronization messages, which allows an anchor in receive mode to distinguish a blink message from a synchronization message. For example, the anchors in the system 700 of FIG. 7B may all be configured to use a first preamble for synchronization messages, and the tags in the system 700 may be configured to use a second preamble for blink messages, wherein the second preamble is different than the first preamble. The timing and scheduling of messages in the system 700 may be viewed as combining elements of DL-TDoA and UL-TDoA. The system 700 uses a DL-TDoA synchronization-type scheme to synchronize the timing of anchors, in a relatively small percentage of time periods (e.g., a 10% duty cycle for DL), as illustrated by “DL” slots in the timing diagrams of FIG. 7A. The system operates in an UL-TDoA manner for the remaining time periods (e.g., a 90% duty cycle for “UL” slots, e.g., as reflected in the timing diagrams of FIG. 7A).

In the system 700, three or more anchors that receive a blink from a tag are able to use TDoA techniques to determine the position of the tag as known in the art. For example, three or more anchors that receive a blink from a tag may compute a respective timestamp associated with the time the blink is received. The respective timestamps may be forwarded to a central location engine (e.g., a server) that determines the tag's location based on the differences in arrival times at each anchor.

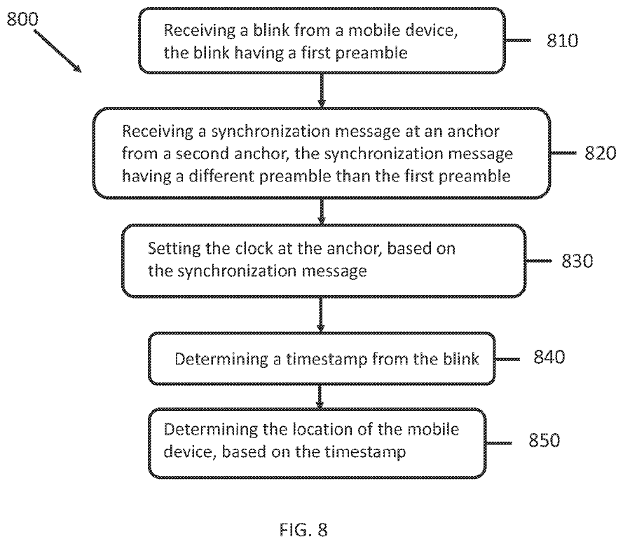

FIG. 8 illustrates a method 800 of synchronizing anchors and receiving blinks in a wireless network, such as the networks in FIGS. 4, 5, and 7, according to some aspects of the disclosure. The steps in method 800 may be performed in an anchor. In step 810, a blink is received from a mobile device, such as a tag, wherein the blink includes a preamble. In step 820, a synchronization message is received at the anchor from a second anchor. The synchronization message has a second preamble that is different than the preamble of the blink. The steps 810 and 820 can be performed in either order. In step 830, the step of setting a clock of the anchor is performed, wherein the clock is set based on a timestamp derived from the synchronization message. In step 840, a time stamp is determined based on the received blink. The time stamp may be related to the time required for the blink to travel from a tag to the anchor. The steps 810 and 840 also can be performed in either order. In step 850, the location of the mobile device is determined/estimated based on the timestamp. Step 850 may involve sending timestamp information to a central location engine that determines the location of the mobile device based on differences in timestamp information among a number of anchors that received the blink.

Persons skilled in the art will recognize that the apparatus, systems, and methods described above can be modified in various ways. Accordingly, persons of ordinary skill in the art will appreciate that the embodiments encompassed by the present disclosure are not limited to the particular exemplary embodiments described above. In that regard, although illustrative embodiments have been shown and described, a wide range of modification, change, and substitution is contemplated in the foregoing disclosure. It is understood that such variations may be made to the foregoing without departing from the scope of the present disclosure. Accordingly, it is appropriate that the appended claims be construed broadly and in a manner consistent with the present disclosure.

What is claimed is:

1. A method of operating an anchor in a communication system, the method comprising:
receiving an uplink message having a preamble from a mobile device; and
receiving a synchronization message having a second preamble from a second anchor, wherein synchronization of the anchor is based on the synchronization message, and wherein the second preamble is different than the preamble.

2. The method of claim 1, wherein the uplink message is blink, and wherein a location of the mobile device is estimated based on the uplink message.

3. The method of claim 1,
wherein the second anchor is part of a first cluster of anchors, the first cluster of anchors comprising a first plurality of anchors,
wherein the anchor is part of the first cluster of anchors and a second cluster of anchors, the second cluster of anchors comprising a second plurality of anchors,
wherein the anchor receives the synchronization message during a first time period designated for synchronization of the first cluster of anchors,
wherein the anchor receives the uplink message during a second time period designated for anchors in the first cluster to receive uplink messages from mobile devices, and
wherein the first time period does not overlap with the second time period.

4. The method of claim 1, wherein the uplink message is a blink, and the mobile device is an UL-Tag.

5. The method of claim 3, further comprising transmitting a second synchronization message to the remaining anchors in the second cluster of anchors during a third time period designated for the remaining anchors to receive synchronization messages and not uplink messages from mobile devices.

6. The method of claim 1, wherein the anchor is part of a first cluster of anchors comprising a plurality of anchors, and wherein there are time periods designated for synchronization of the first cluster of anchors and different time periods designated for the first cluster of anchors to receive uplink messages from mobile devices.

7. The method of claim 6, wherein the uplink message is a blink and wherein the mobile device is a tag, the method further comprising:
receiving the uplink message from the mobile device, by at least two other anchors in the first cluster other than the anchor;
determining a timestamp at each anchor that receives the uplink message; and
sending the respective timestamps to a central location engine to estimate the location of the mobile device.

8. An anchor comprising:
a transceiver configured to:
receive an uplink message having a preamble from a mobile device; and
receive a synchronization message having a second preamble from a second anchor,
wherein synchronization of the anchor is based on the synchronization message, and wherein the second preamble is different than the preamble.

9. The anchor of claim 8, wherein the uplink message is blink, and wherein the mobile device is a UT-Tag, and wherein the anchor is configured to be part of an ultrawideband network.

10. The anchor of claim 8,
wherein the second anchor is part of a first cluster of anchors, the first cluster of anchors comprising a first plurality of anchors,
wherein the anchor is part of the first cluster of anchors and a second cluster of anchors, the second cluster of anchors comprising a second plurality of anchors,
wherein the anchor receives the synchronization message during a first time period designated for synchronization of the first cluster of anchors,
wherein the anchor receives the uplink message during a second time period designated for anchors in the first cluster to receive uplink messages from mobile devices, and
wherein the first time period does not overlap with the second time period.

11. The anchor of claim 8, wherein the anchor is configured to operate in a FiRa network.

12. The anchor of claim 8,
wherein the anchor is configured to be part of a first cluster of anchors comprising a plurality of anchors,
wherein there is a first time period designated for synchronization of the first cluster of anchors and a second time period designated for the first cluster of anchors to receive uplink messages from mobile devices including the uplink message,
wherein the uplink messages are blinks, and
wherein first cluster of anchors does not receive blinks from mobile devices during the first time period.

13. The anchor of claim 12, wherein a DT-Poll message format using the second preamble is used for the synchronization message.

14. A ultra-wideband (UWB) device comprising:
a transceiver;
a processor;
a non-transitory memory including a set of instructions stored therein and executable by the processor to cause the transceiver to:
receive an uplink message having a preamble from a mobile device;
receive a synchronization message having a second preamble from an anchor, wherein synchronization of the UWB device is based on the synchronization message, and wherein the second preamble is different than the preamble.

15. The UWB device of claim 14, wherein the uplink message is blink, and wherein the mobile device is a UT-Tag, and wherein UWB device is configured to be part of an ultrawideband network.

16. The UWB device of claim 14, wherein the anchor is part of a first cluster of anchors, the first cluster of anchors comprising a first plurality of anchors,
wherein the UWB device is part of the first cluster of anchors and a second cluster of anchors, the second cluster of anchors comprising a second plurality of anchors,
wherein the UWB device receives the synchronization message during a first time period designated for synchronization of the first cluster of anchors,
wherein the UWB device receives the uplink message during a second time period designated for anchors in the first cluster to receive uplink messages from mobile devices, and
wherein the first time period does not overlap with the second time period.

17. The UWB device of claim 14, wherein the UWB device is configured to operate in a FiRa network.

18. The UWB device of claim 16, wherein the non-transitory memory further includes a set of instructions stored therein and executable by the processor to cause the transceiver to:
transmit a second synchronization message to the remaining anchors in the second cluster of anchors during a third time period designated for the remaining anchors to receive synchronization messages and not uplink messages from mobile devices.

19. The UWB device of claim 14, wherein the UWB device is part of a first cluster of anchors comprising a plurality of anchors, and wherein there are time periods designated for synchronization of the first cluster of anchors using the preamble, and different time periods designated for the first cluster of anchors to receive uplink messages from mobile devices using the second preamble.

20. The UWB device of claim 16, wherein the UWB device switches its physical layer configuration to use the preamble to receive the uplink message during the second time period, and wherein the UWB switches its physical layer configuration to use the second preamble to receive the synchronization message during the first time period.
